(19) United States
(12) Patent Application Publication
(10) Pub. No.: US 2024/0342564 A1
(43) Pub. Date: Oct. 17, 2024

(54) GOLF BALL WASHING DEVICE

(71) Applicant: Dale Holtz, Abbotsford (CA)

(72) Inventor: Dale Holtz, Abbotsford (CA)

(21) Appl. No.: 18/298,457

(22) Filed: Apr. 11, 2023

(51) Int. Cl. A63B 47/04; B08B 1/00

(52) U.S. Cl. CPC A63B 47/04; B08B 1/143; B08B 1/30

(57) ABSTRACT

A golf ball washing device operable to provide cleaning of the outer surface of a golf ball and be carried in a golf bag or secured to a golf cart. The present invention includes a housing having a lower portion and an upper portion that are releasably secured. The lower portion has in the interior volume thereof a first section of a golf ball receiving member. A first cleaning member is disposed on the first section of the golf ball receiving member. A second section of the golf ball receiving member is rotatably mounted within the interior volume of the upper portion of the housing. The second section of the golf ball receiving member includes a second cleaning member. The first section and second section of the golf ball receiving member are mateably half dome shaped so as to surroundably cover a golf ball ensuing assembly of the housing.

### FIELD OF THE INVENTION

The present invention relates generally to golf accessories, more specifically but not by way of limitation, a portable golf ball washing device that is configured to clean the surface of a golf ball and is further operable to be releasably coupled to a golf bag.

### BACKGROUND

Millions of people play golf on a daily basis and it is a sport that is participated in by men and women of all ages. An important part of being successful in a round of golf in maintenance of the equipment during the round of golf. By way of example but not limitation, the grooves on the golf club face should be brushed and cleaned so as to ensure no debris or dirt is lodged in the grooves. Clubs that have the grooves that are filled with dirt or debris will not place the proper spin on the ball when the club is utilized.

Another important maintenance task during a round of golf is ensuring the golf ball surface remains clean. Often during a round of golf the surface will have mud or other debris stick thereto. If the golf ball surface is not cleaned the golf ball will not perform correctly and can have a negative impact on parameters such as but not limited to ball flight and putting. There are ball cleaners available on golf courses but may only be present on a few tee boxes. Golfer will utilize towels and other apparatus to clean the surface of the golf ball but more effective tools are needed.

Accordingly, there is a need for a portable golf ball cleaning device that is configured to provide cleaning of the golf ball surface wherein the present invention can also be secured to a golf cart or carried in a golf bag to make available for use during an entire round of golf.

### SUMMARY OF THE INVENTION

It is the object of the present invention to provide a portable golf ball cleaning device configured to provide cleaning of the surface of a golf ball wherein the present invention includes a housing manufactured from a rigid material such as but not limited to plastic.

Another object of the present invention is to provide a golf ball cleaner operable to provide removal of dirt and debris from the surface of a golf ball wherein the housing includes a lower portion and an upper portion.

A further object of the present invention is to provide a portable golf ball cleaning device configured to provide cleaning of the surface of a golf ball wherein the housing includes an interior volume of suitable size to accommodate a golf ball therein.

Yet a further object of the present invention is to provide a golf ball cleaner operable to provide removal of dirt and debris from the surface of a golf ball wherein the lower portion has a first section of a golf ball receiving member secured therein.

Still another object of the present invention is to provide a portable golf ball cleaning device configured to provide cleaning of the surface of a golf ball wherein the first section of the golf ball receiving member includes a first cleaning member.

An additional object of the present invention is to provide a golf ball cleaner operable to provide removal of dirt and debris from the surface of a golf ball wherein the upper portion includes a second portion of a golf ball receiving member extending downward from the inner surface of the top of the upper portion of the housing.

Yet a further object of the present invention is to provide a portable golf ball cleaning device configured to provide cleaning of the surface of a golf ball wherein the second portion of the golf ball receiving member has disposed therein a second cleaning member.

Another object of the present invention is to provide a golf ball cleaner operable to provide removal of dirt and debris from the surface of a golf ball wherein the second portion of the golf ball receiving member is rotatably mounted within housing having a handle operably coupled thereto mounted on the top of the upper portion of the housing.

To the accomplishment of the above and related objects the present invention may be embodied in the form illustrated in the accompanying drawings. Attention is called to the fact that the drawings are illustrative only. Variations are contemplated as being a part of the present invention, limited only by the scope of the claims.

### BRIEF DESCRIPTION OF THE DRAWINGS

A more complete understanding of the present invention may be had by reference to the following Detailed Description and appended claims when taken in conjunction with the accompanying Drawings wherein:

FIG. 1 is a perspective view of the interior of the upper portion of the housing of the present invention; and

FIG. 2 is a side view of the present invention; and

FIG. 3 is a top view of the interior of the lower portion of the housing.

### DETAILED DESCRIPTION

Referring now to the drawings submitted herewith, wherein various elements depicted therein are not necessarily drawn to scale and wherein through the views and figures like elements are referenced with identical reference numerals, there is illustrated a golf ball washing device 100 constructed according to the principles of the present invention.

An embodiment of the present invention is discussed herein with reference to the figures submitted herewith. Those skilled in the art will understand that the detailed description herein with respect to these figures is for explanatory purposes and that it is contemplated within the scope of the present invention that alternative embodiments are plausible. By way of example but not by way of limitation, those having skill in the art in light of the present teachings of the present invention will recognize a plurality of alternate and suitable approaches dependent upon the needs of the particular application to implement the functionality of any given detail described herein, beyond that of the particular implementation choices in the embodiment described herein. Various modifications and embodiments are within the scope of the present invention.

It is to be further understood that the present invention is not limited to the particular methodology, materials, uses and applications described herein, as these may vary. Furthermore, it is also to be understood that the terminology used herein is used for the purpose of describing particular embodiments only, and is not intended to limit the scope of the present invention. It must be noted that as used herein and in the claims, the singular forms “a”, “an” and “the” include the plural reference unless the context clearly dictates otherwise. Thus, for example, a reference to “an element” is a reference to one or more elements and includes equivalents thereof known to those skilled in the art. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

References to “one embodiment”, “an embodiment”, “exemplary embodiments”, and the like may indicate that the embodiment(s) of the invention so described may include a particular feature, structure or characteristic, but not every embodiment necessarily includes the particular feature, structure or characteristic.

Referring in particular to the Figures submitted herewith, the golf ball washing device 100 includes a housing 10 wherein the housing 10 is manufactured from a durable rigid material such as but not limited to plastic. The housing 10 is cylindrical in shape and includes a lower portion 20 and an upper portion 25. The lower portion 20 and upper portion 25 are configured to be releasably secured to each other so as to facilitate removal of the upper portion 25 in order to place a golf ball in the interior volume 21 of the lower portion, specifically in the first section of the golf ball receiving member 40 as is further discussed herein. It should be understood within the scope of the present invention that the lower portion 20 and upper portion 25 are releasably secured utilizing threads or other suitable techniques. Upper portion 25 includes rib members 26 formed on the outer surface thereof. Rib members 26 are vertical in orientation and provide an improved grasp of the housing 10 during use of the golf ball washing device 100. It should be understood within the scope of the present invention that the housing 10 could be manufactured in alternate sizes and further be configured to be transported in a golf bag or secured to a golf cart.

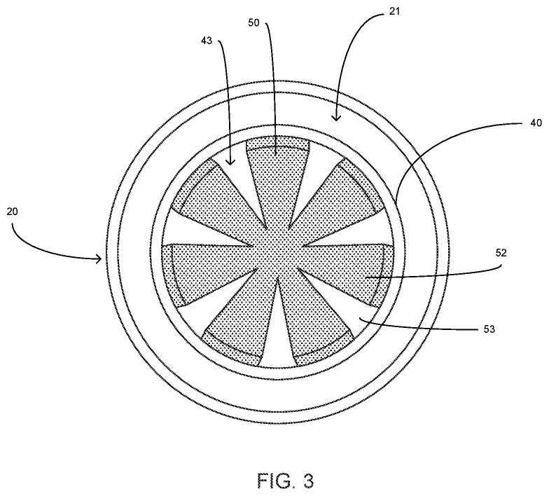

Referring in particular to FIG. 3 the lower portion 20 of the housing 10 is illustrated therein. The lower portion 20 has secured within the interior volume 21 thereof the first section of the golf ball receiving member 40. The first section of the golf ball receiving member 40 is secured or formed within the interior volume 21 utilizing suitable durable techniques. The first section of the golf ball receiving member 40 is half-dome shaped and of a size that will mateably accommodate a golf ball therein. Within the interior volume 43 of the first section of the golf ball receiving member 40 there is a first cleaning member 50. The first cleaning member 50 is manufactured from an abrasive material such as but not limited to a scouring pad. The first cleaning member 50 is provided in segments 52 wherein the segments 52 have a void 53 therebetween. The segments 52 are circumferentially disposed around the entire interior volume 43 on the inner surface of the first section of the golf ball receiving member 40. The voids 53 present between the segments 52 provide a technique for larger pieces of dirt and debris to fall therein so as to maintain a cleaner surface of the segments during cleaning of a golf ball. It should be understood within the scope of the present invention that the first cleaning member 50 could be present on the entire inner surface of the first section of the golf ball receiving member 40. Furthermore, alternate quantities of segments 52 could be employed.

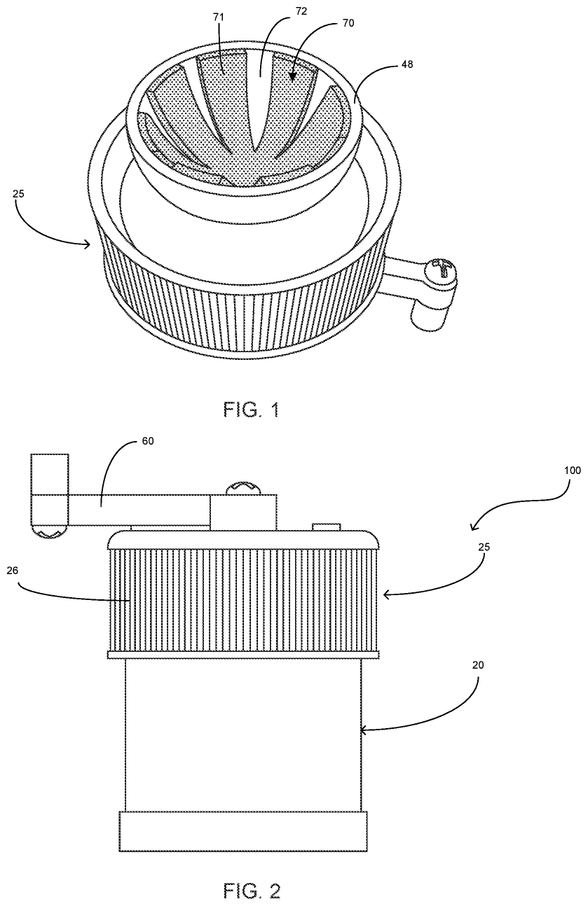

Now referring in particular to FIG. 1 submitted herewith, the interior of the upper portion 25 of the golf ball washing device 100 is illustrated therein. Rotatably secured within the interior volume of the upper portion 25 of the housing 10 is the second section of the golf ball receiving member 48. The second section of the golf ball receiving member 48 is rotatably mounted within the upper portion 25 utilizing suitable techniques. Handle 60 is employed by a user of the golf ball washing device 100 to facilitate rotational movement of the second section of the golf ball receiving member 48. The second section of the golf ball receiving member 48 is half-dome shaped of mateable size to the first section of the golf ball receiving member 40. The mateable shape of the first section of the golf ball receiving member 40 and the second section of the golf ball receiving member 48 provide a surroundable coverage of a golf ball ensuing coupling of the lower portion 20 and upper portion 25 of the housing 10.

The second section of the golf ball receiving member 48 includes a second cleaning member 70 secured on the inner surface thereof wherein the second cleaning member is manufactured from the same material as the first cleaning member 50. The second cleaning member 70 is similarly manufactured as the first cleaning member 50 having segments 71 with voids 72 present between the segments 71. Rotational movement of the handle 60 provides rotation of the second section of the golf ball receiving member 48 and the first cleaning member 50 and second cleaning member 70 provide effective cleaning of a golf ball. It should be understood within the scope of the present invention that the second section of the golf ball receiving member 48 could have rotation thereof driven with alternate elements such as but not limited to an electric motor.

In the preceding detailed description, reference has been made to the accompanying drawings that form a part hereof, and in which are shown by way of illustration specific embodiments in which the invention may be practiced. These embodiments, and certain variants thereof, have been described in sufficient detail to enable those skilled in the art to practice the invention. It is to be understood that other suitable embodiments may be utilized and that logical changes may be made without departing from the spirit or scope of the invention. The description may omit certain information known to those skilled in the art. The preceding detailed description is, therefore, not intended to be limited to the specific forms set forth herein, but on the contrary, it is intended to cover such alternatives, modifications, and equivalents, as can be reasonably included within the spirit and scope of the appended claims.

What is claimed is:

1. A golf ball cleaning device operable to clean an outer surface of a golf ball wherein the golf ball cleaning device comprises:
a housing, said housing having an upper portion and a lower portion, said upper portion and said lower portion being releasably secured, said housing having an interior volume;
a golf ball receiving member, said golf ball receiving member having a first section and a second section, said first section of said golf ball receiving member being disposed in said lower portion of said housing, said first section of said golf ball receiving member being half dome shaped, said first section of said golf ball receiving member having a first cleaning member disposed on an inner surface of the first section of the golf ball receiving member, said golf ball receiving member having a second section, said second section of said golf ball receiving member being half dome shaped and sized to mateably join the first section of the golf ball receiving member to encompass a golf ball placed within the golf ball receiving member, said second section of said golf ball receiving member being rotatably mounted within said upper portion of said housing, said second section of the golf ball receiving member having a second cleaning member secured to an inner surface thereof; and
wherein the second section of the golf ball receiving member is rotated ensuing coupling of the upper portion and lower portion of the housing to clean an outer surface of a golf ball disposed within the golf ball receiving member.

2. The golf ball cleaning device operable to clean the outer surface of a golf ball as recited in claim 1, and further including a handle, said handle being operably coupled to said second section of the golf ball receiving member, said handle configured to provide rotational movement of the second section of the golf ball receiving member.

3. The golf ball cleaning device operable to clean the outer surface of a golf ball as recited in claim 2, wherein said upper portion further includes a multitude of rib members, said rib members being formed on an outer surface of said upper portion, said rib members being vertical in orientation, said rib members configured to facilitate grasping the upper portion.

4. The golf ball cleaning device operable to clean the outer surface of a golf ball as recited in claim 3, wherein the first cleaning member includes a plurality of segments, said segments having a void therebetween.

5. The golf ball cleaning device operable to clean the outer surface of a golf ball as recited in claim 4, wherein the second cleaning member includes a plurality of segments, said segments of said second cleaning member having voids therebetween.

6. The golf ball cleaning device operable to clean the outer surface of a golf ball as recited in claim 5, wherein said first cleaning member and said second cleaning member are manufactured from scouring pads.

7. The golf ball cleaning device operable to clean the outer surface of a golf ball as recited in claim 6, wherein the segments of said second cleaning member extend from a perimeter edge of the second section of the golf ball receiving member to a central point and are tapered in shape.

8. The golf ball cleaning device operable to clean the outer surface of a golf ball as recited in claim 7, wherein the segments of said first cleaning member extend from a perimeter edge of the first section of the golf ball receiving member to a central point and are tapered in shape.
